(19) United States
(12) Patent Application Publication
(10) Pub. No.: US 2023/0148040 A1
(43) Pub. Date: May 11, 2023

(54) APPARATUS AND METHOD FOR MELTING GLASS WITH THERMAL PLASMA

(71) Applicant: Corning Incorporated, Corning, NY (US)

(72) Inventor: Andrew Voss Welles, Horseheads, NY (US)

(21) Appl. No.: 17/920,537

(22) PCT Filed: May 3, 2021
(86) PCT No.: PCT/US2021/030401

§ 371 Date: Oct. 21, 2022

Related U.S. Application Data
(60) Provisional application No. 63/022,001, filed on May 8, 2020.

(51) Int. Cl. C03B 3/02; C03B 5/235

(52) U.S. Cl. CPC C03B 3/026; C03B 5/235; C03B 2211/25

(57) ABSTRACT

An apparatus and method for melting raw batch materials into molten glass includes feeding raw batch materials into a chamber through a feed port, heating the chamber with a plurality of plasma torches positioned above a predetermined level, each plasma torch emitting a plasma flame into the chamber, and melting the raw batch materials into molten glass up to the predetermined level.

This Application claims priority under 35 USC § 119(e) from U.S. Provisional Patent Application Ser. No. 63/022,001 filed on May 8, 2020, which is incorporated by reference herein in its entirety.

### FIELD

The present disclosure relates generally to melting raw batch materials into molten glass and more specifically to melting raw batch materials into molten glass using thermal plasma.

### BACKGROUND

In the production of glass articles, such as glass sheets for display applications, including televisions and hand-held devices, such as telephones and tablets, mostly solid raw batch materials are typically melted into molten glass in a melting vessel. In order to heat the area above the molten glass, melting vessels often employ one or more combustion burners, wherein a hydrocarbon containing fuel source, such as natural gas, reacts with oxygen in order to generate a hot flame above the surface of the molten glass.

Such combustion-based heating can, however, involve several potential drawbacks. For example, combustion of hydrocarbons results in the production of carbon-containing gasses, such as carbon dioxide and carbon monoxide, which emissions are widely recognized as contributors to climate change and increasingly subject to regulation and/or taxation in jurisdictions around the world. Combustion of hydrocarbons also typically results in the production of other emissions considered environmentally harmful, such as oxides of nitrogen (NOx), which may require the use of pollution control equipment to reduce emissions to an acceptable level. In addition, the cost and/or composition of hydrocarbon-containing fuels, such as natural gas, can vary substantially over time and/or in certain parts of the world, leading to unpredictability and/or undesirable variability in not only cost but also energy output of combustion. Accordingly, it would be desirable to heat a melting vessel in a manner that minimizes one or more of these drawbacks.

### SUMMARY

Embodiments disclosed herein include an apparatus for melting raw batch materials into molten glass. The apparatus includes a chamber configured to confine molten glass up to a predetermined level within the chamber. The apparatus also includes a feed port configured to feed raw batch materials into the chamber. In addition, the apparatus includes a plurality of thermal plasma torches positioned above the predetermined level, each plasma torch configured to thermally decompose a working fluid fed therein and emit a plasma flame into the chamber.

Embodiments disclosed herein also include a method for melting raw batch materials into molten glass. The method includes feeding raw batch materials into a chamber through a feed port. The method also includes heating the chamber with a plurality of plasma torches positioned above a predetermined level in the chamber, each plasma torch thermally decomposing a working fluid fed therein and emitting a plasma flame into the chamber. In addition, the method includes melting the raw batch materials into molten glass up to the predetermined level.

Additional features and advantages of the embodiments disclosed herein will be set forth in the detailed description which follows, and in part will be readily apparent to those skilled in the art from that description or recognized by practicing the disclosed embodiments as described herein, including the detailed description which follows, the claims, as well as the appended drawings.

It is to be understood that both the foregoing general description and the following detailed description present embodiments intended to provide an overview or framework for understanding the nature and character of the claimed embodiments. The accompanying drawings are included to provide further understanding and are incorporated into and constitute a part of this specification. The drawings illustrate various embodiments of the disclosure, and together with the description serve to explain the principles and operations thereof.

### BRIEF DESCRIPTION OF THE DRAWINGS

FIG. 1 is a schematic view of an example fusion down draw glass making apparatus and process;

FIG. 2 is a schematic side cutaway view of an example glass melting vessel in accordance with embodiments disclosed herein;

FIG. 3 is schematic top cutaway view of the example glass melting vessel of FIG. 2;

FIG. 4 is schematic end cutaway view of the example glass melting vessel of FIGS. 2 and 3; and

FIG. 5 is a schematic side cutaway view of an example plasma torch in accordance with embodiments disclosed herein.

### DETAILED DESCRIPTION

Reference will now be made in detail to the present preferred embodiments of the present disclosure, examples of which are illustrated in the accompanying drawings. Whenever possible, the same reference numerals will be used throughout the drawings to refer to the same or like parts. However, this disclosure may be embodied in many different forms and should not be construed as limited to the embodiments set forth herein.

Ranges can be expressed herein as from “about” one particular value, and/or to “about” another particular value. When such a range is expressed, another embodiment includes from the one particular value and/or to the other particular value. Similarly, when values are expressed as approximations, for example by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

As used herein, the term “raw batch materials” refers to mostly solid materials, such as solid metal oxides, that are fed into a chamber of a melting furnace to be melted into molten glass.

As used herein, the term “molten glass” refers to a glass composition that is at or above its liquidous temperature (the temperature above which no crystalline phase can coexist in equilibrium with the glass).

As used herein, the term “thermal plasma torch” refers to a device that directs a flow of plasma generated from a working fluid that is fed into the thermal plasma torch and is thermally decomposed upon subjection to an energy source within the thermal plasma torch. Exemplary thermal plasma torches include those that employ direct current (DC), alternating current (AC), and radio frequency (RF) to thermally decompose the working fluid and generate the flow of plasma.

As used herein, the term “plasma flame” refers to the flow of plasma that projects out of a thermal plasma torch.

As used herein, the term “combustion burner” refers to a device that primarily generates heat from combustion of a fuel, the term “combustion” referring to exothermic redox chemical reaction(s) between the fuel, such as natural gas, and an oxidant, such as oxygen from air.

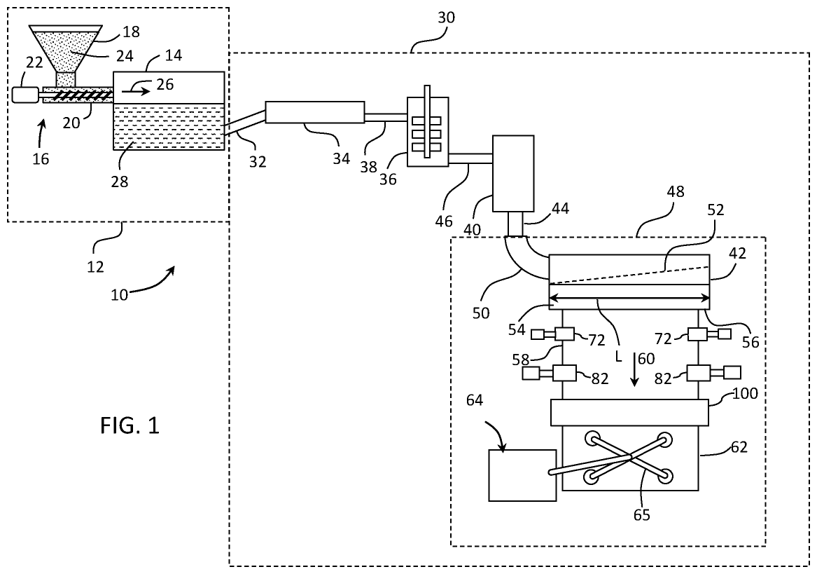

Shown in FIG. 1 is an exemplary glass manufacturing apparatus 10. In some examples, the glass manufacturing apparatus 10 can comprise a glass melting furnace 12 that can include a melting vessel 14. In addition to melting vessel 14, glass melting furnace 12 includes one or more additional components, such as heating elements (as will be described in more detail herein) that heat raw materials and convert the raw materials into molten glass. In further examples, glass melting furnace 12 may include thermal management devices (e.g., insulation components) that reduce heat lost from a vicinity of the melting vessel. In still further examples, glass melting furnace 12 may include electronic devices and/or electromechanical devices that facilitate melting of the raw materials into a glass melt. Still further, glass melting furnace 12 may include support structures (e.g., support chassis, support member, etc.) or other components.

Glass melting vessel 14 is typically comprised of refractory material, such as a refractory ceramic material, for example a refractory ceramic material comprising alumina or zirconia. In some examples glass melting vessel 14 may be constructed from refractory ceramic bricks. Specific embodiments of glass melting vessel 14 will be described in more detail below.

In some examples, the glass melting furnace may be incorporated as a component of a glass manufacturing apparatus to fabricate a glass substrate, for example a glass ribbon of a continuous length. In some examples, the glass melting furnace of the disclosure may be incorporated as a component of a glass manufacturing apparatus comprising a slot draw apparatus, a float bath apparatus, a down-draw apparatus such as a fusion process, an up-draw apparatus, a press-rolling apparatus, a tube drawing apparatus or any other glass manufacturing apparatus that would benefit from the aspects disclosed herein. By way of example, FIG. 1 schematically illustrates glass melting furnace 12 as a component of a fusion down-draw glass manufacturing apparatus 10 for fusion drawing a glass ribbon for subsequent processing into individual glass sheets.

The glass manufacturing apparatus 10 (e.g., fusion down-draw apparatus 10) can optionally include an upstream glass manufacturing apparatus 16 that is positioned upstream relative to glass melting vessel 14. In some examples, a portion of, or the entire upstream glass manufacturing apparatus 16, may be incorporated as part of the glass melting furnace 12.

As shown in the illustrated example, the upstream glass manufacturing apparatus 16 can include a storage bin 18, a raw material delivery device 20 and a motor 22 connected to the raw material delivery device. Storage bin 18 may be configured to store a quantity of raw batch materials 24 that can be fed into melting vessel 14 of glass melting furnace 12, as indicated by arrow 26. Raw batch materials 24 typically comprise one or more glass forming metal oxides and one or more modifying agents. In some examples, raw material delivery device 20 can be powered by motor 22 such that raw material delivery device 20 delivers a predetermined amount of raw batch materials 24 from the storage bin 18 to melting vessel 14. In further examples, motor 22 can power raw material delivery device 20 to introduce raw batch materials 24 at a controlled rate based on a level of molten glass sensed downstream from melting vessel 14. Raw batch materials 24 within melting vessel 14 can thereafter be heated to form molten glass 28.

Glass manufacturing apparatus 10 can also optionally include a downstream glass manufacturing apparatus 30 positioned downstream relative to glass melting furnace 12. In some examples, a portion of downstream glass manufacturing apparatus 30 may be incorporated as part of glass melting furnace 12. In some instances, first connecting conduit 32 discussed below, or other portions of the downstream glass manufacturing apparatus 30, may be incorporated as part of glass melting furnace 12. Elements of the downstream glass manufacturing apparatus, including first connecting conduit 32, may be formed from a precious metal. Suitable precious metals include platinum group metals selected from the group of metals consisting of platinum, iridium, rhodium, osmium, ruthenium and palladium, or alloys thereof. For example, downstream components of the glass manufacturing apparatus may be formed from a platinum-rhodium alloy including from about 70 to about 90% by weight platinum and about 10% to about 30% by weight rhodium. However, other suitable metals can include molybdenum, palladium, rhenium, tantalum, titanium, tungsten and alloys thereof.

Downstream glass manufacturing apparatus 30 can include a first conditioning (i.e., processing) vessel, such as fining vessel 34, located downstream from melting vessel 14 and coupled to melting vessel 14 by way of the above-referenced first connecting conduit 32. In some examples, molten glass 28 may be gravity fed from melting vessel 14 to fining vessel 34 by way of first connecting conduit 32. For instance, gravity may cause molten glass 28 to pass through an interior pathway of first connecting conduit 32 from melting vessel 14 to fining vessel 34. It should be understood, however, that other conditioning vessels may be positioned downstream of melting vessel 14, for example between melting vessel 14 and fining vessel 34. In some embodiments, a conditioning vessel may be employed between the melting vessel and the fining vessel wherein molten glass from a primary melting vessel is further heated to continue the melting process or cooled to a temperature lower than the temperature of the molten glass in the melting vessel before entering the fining vessel.

Bubbles may be removed from molten glass 28 within fining vessel 34 by various techniques. For example, raw batch materials 24 may include multivalent compounds (i.e. fining agents) such as tin oxide that, when heated, undergo a chemical reduction reaction and release oxygen. Other suitable fining agents include without limitation arsenic, antimony, iron and cerium. Fining vessel 34 is heated to a temperature greater than the melting vessel temperature, thereby heating the molten glass and the fining agent. Oxygen bubbles produced by the temperature-induced chemical reduction of the fining agent(s) rise through the molten glass within the fining vessel, wherein gases in the molten glass produced in the melting furnace can diffuse or coalesce into the oxygen bubbles produced by the fining agent. The enlarged gas bubbles can then rise to a free surface of the molten glass in the fining vessel and thereafter be vented out of the fining vessel. The oxygen bubbles can further induce mechanical mixing of the molten glass in the fining vessel.

Downstream glass manufacturing apparatus 30 can further include another conditioning vessel such as a mixing vessel 36 for mixing the molten glass. Mixing vessel 36 may be located downstream from the fining vessel 34. Mixing vessel 36 can be used to provide a homogenous glass melt composition, thereby reducing cords of chemical or thermal inhomogeneity that may otherwise exist within the fined molten glass exiting the fining vessel. As shown, fining vessel 34 may be coupled to mixing vessel 36 by way of a second connecting conduit 38. In some examples, molten glass 28 may be gravity fed from the fining vessel 34 to mixing vessel 36 by way of second connecting conduit 38. For instance, gravity may cause molten glass 28 to pass through an interior pathway of second connecting conduit 38 from fining vessel 34 to mixing vessel 36. It should be noted that while mixing vessel 36 is shown downstream of fining vessel 34, mixing vessel 36 may be positioned upstream from fining vessel 34. In some embodiments, downstream glass manufacturing apparatus 30 may include multiple mixing vessels, for example a mixing vessel upstream from fining vessel 34 and a mixing vessel downstream from fining vessel 34. These multiple mixing vessels may be of the same design, or they may be of different designs.

Downstream glass manufacturing apparatus 30 can further include another conditioning vessel such as delivery vessel 40 that may be located downstream from mixing vessel 36. Delivery vessel 40 may condition molten glass 28 to be fed into a downstream forming device. For instance, delivery vessel 40 can act as an accumulator and/or flow controller to adjust and/or provide a consistent flow of molten glass 28 to forming body 42 by way of exit conduit 44. As shown, mixing vessel 36 may be coupled to delivery vessel 40 by way of third connecting conduit 46. In some examples, molten glass 28 may be gravity fed from mixing vessel 36 to delivery vessel 40 by way of third connecting conduit 46. For instance, gravity may drive molten glass 28 through an interior pathway of third connecting conduit 46 from mixing vessel 36 to delivery vessel 40.

Downstream glass manufacturing apparatus 30 can further include forming apparatus 48 comprising the above-referenced forming body 42 and inlet conduit 50. Exit conduit 44 can be positioned to deliver molten glass 28 from delivery vessel 40 to inlet conduit 50 of forming apparatus 48. For example, exit conduit 44 may be nested within and spaced apart from an inner surface of inlet conduit 50, thereby providing a free surface of molten glass positioned between the outer surface of exit conduit 44 and the inner surface of inlet conduit 50. Forming body 42 in a fusion down draw glass making apparatus can comprise a trough 52 positioned in an upper surface of the forming body and converging forming surfaces 54 that converge in a draw direction along a bottom edge 56 of the forming body. Molten glass delivered to the forming body trough via delivery vessel 40, exit conduit 44 and inlet conduit 50 overflows side walls of the trough and descends along the converging forming surfaces 54 as separate flows of molten glass. The separate flows of molten glass join below and along bottom edge 56 to produce a single ribbon of glass 58 that is drawn in a draw or flow direction 60 from bottom edge 56 by applying tension to the glass ribbon, such as by gravity, edge rolls 72 and pulling rolls 82, to control the dimensions of the glass ribbon as the glass cools and a viscosity of the glass increases. Accordingly, glass ribbon 58 goes through a visco-elastic transition and acquires mechanical properties that give the glass ribbon 58 stable dimensional characteristics. Glass ribbon 58 may, in some embodiments, be separated into individual glass sheets 62 by a glass separation apparatus 100 in an elastic region of the glass ribbon. A robot 64 may then transfer the individual glass sheets 62 to a conveyor system using gripping tool 65, whereupon the individual glass sheets may be further processed.

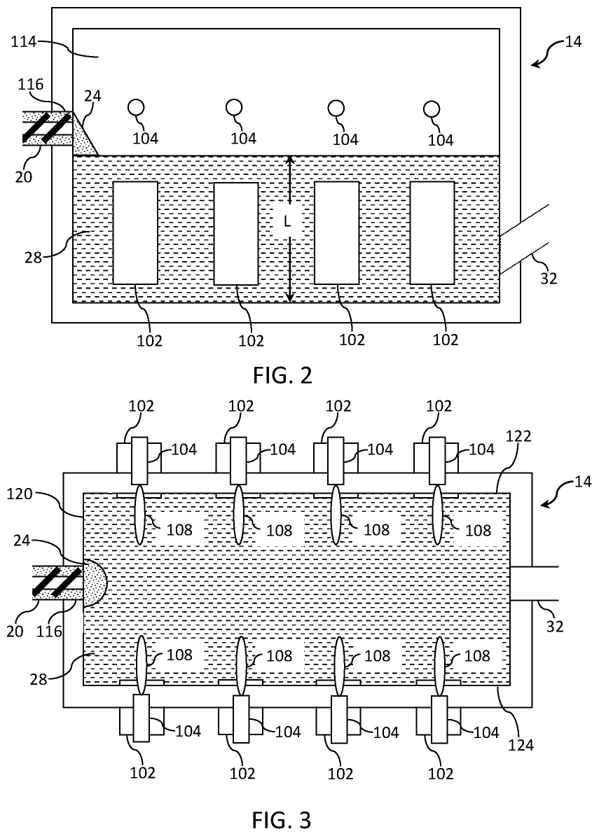

FIG. 2 shows a schematic side cutaway view of an example glass melting vessel 14 in accordance with embodiments disclosed herein. Glass melting vessel 14 includes a chamber 114 wherein raw material delivery device 20 delivers a predetermined amount of raw batch materials 24 into the chamber 114 through feed port 116. Glass melting vessel 14 also includes a plurality of electrodes 102 and a plurality of thermal plasma torches 104.

In operation, plurality of electrodes 102 and plurality of thermal plasma torches 104 heat chamber 114 such that raw batch materials 24 are melted into molten glass 28 up to a predetermined level (L) within chamber 114. As can be seen in FIG. 2, plurality of plasma torches 104 are positioned above the predetermined level (L) and plurality of electrodes 102 are positioned below the predetermined level (L).

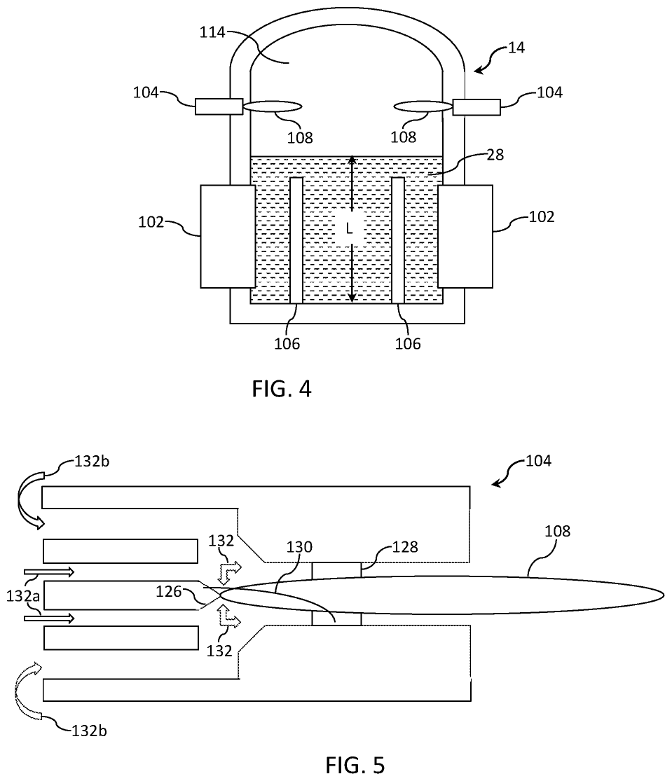

FIGS. 3 and 4, show, respectively, schematic top and end cutaway views of the example glass melting vessel 14 of FIG. 2. As can be seen in FIGS. 3 and 4, each plasma torch 104 emits a plasma flame 108 into the chamber 114. In addition, as shown in FIG. 3, feed port 116 is positioned on a first wall 120 of the chamber 114 and the plurality of thermal plasma torches 104 are positioned on second and third walls 122, 124 of the chamber 114, the second and third walls 122, 124 each extending in directions that are generally parallel to each other and generally perpendicular to the first wall 120. Moreover, as shown in FIG. 3, raw batch materials 24 are fed into the chamber 114 without the raw batch materials 24 contacting the plasma flame 108 of any of the plurality of plasma torches 104. For example, embodiments disclosed herein include those in which raw batch materials 24 are fed into the chamber 114 at a predetermined distance away from the nearest plasma flame 108, such as a distance of at least about 1 meter away from the nearest plasma flame 108, including a distance of from about 1 meter to about 10 meters away, such as from about 2 meters to about 5 meters away from the nearest plasma flame 108.

As shown in FIG. 4, glass melting vessel 14 includes electrodes 106 extending from bottom of chamber 114, wherein electrodes 106 are positioned below the predetermined level (L). As further shown in FIG. 4, plasma torches 104 emit plasma flames 108 in a direction that is generally parallel to predetermined level (L).

While FIGS. 2-4, show a glass melting vessel 14 that includes electrodes 102 extending from walls of chamber 114 and electrodes 106 extending from the bottom of chamber 114, embodiments disclosed herein can include those in which only electrodes extending from walls of chamber 114, only electrodes 106 extending from the bottom of chamber 114, or neither type of electrode is included in glass melting vessel 14. Each of the electrodes 102 and/or 106 can be connected to one or more power sources (not shown) according to methods known to persons having ordinary skill in the art.

Embodiments disclosed herein also include those in which glass melting vessel 14 does not include a combustion burner.

FIG. 5 shows a schematic side cutaway view of an example plasma torch 104 in accordance with embodiments disclosed herein. Plasma torch 104 shown in FIG. 5 is a direct current (DC) plasma torch that includes cathode 126 and anode 128, which when sourced with electrical power, ignites plasma arc 130 and energizes a working fluid 132 fed into the plasma torch 104 in order to generate plasma flame 108.

While FIG. 5 shows a DC plasma torch, embodiments disclosed herein include those in which plurality of plasma torches 104, for example, comprise alternating current (AC), direct current (DC), or radio frequency (RF) plasma torches. Such plasma torches can, for example, include commercially available AC, DC, or RF plasma torches that can be incorporate or retrofitted to be incorporated into a glass melting vessel 14 in accordance with knowledge of persons having ordinary skill in the art. Exemplary commercially available plasma torches include but are not limited to DC industrial steam plasma torches available from Plazarium.

While not limited to any particular fluid, the working fluid 132 can, for example, be selected from water, hydrogen, helium, neon, and/or argon. Accordingly, exemplary embodiments include those in which each of the plurality of plasma torches 104 thermally decomposes a working fluid 132 selected from water, hydrogen, helium, neon, and/or argon.

In certain exemplary embodiments, the working fluid 132 is water.

In certain exemplary embodiments, plasma flame 108 generated by thermal decomposition of the working fluid 132 fed in plasma torch 104 can have a temperature of at least about 2000° C., such as at least about 2500° C., and further such as at least about 3000° C., including from about 2000° C. to about 30,000° C., such as from about 2500° C. to about 25,000° C., and further such as from about 3000° C. to about 20,000° C.

Embodiments disclosed herein include those in which at least a portion of working fluid 132 fed in each of the plurality of plasma torches 104 has been recycled into plasma torches 104 through melting vessel 14. For example, as shown in FIG. 5, primary (unrecycled) working fluid 132a from a working fluid source and recycled working fluid 132b from melting vessel 14 are both fed into plasma torch 104 and mixed to generate working fluid 132. In certain exemplary embodiments, at least about 90%, such as at least about 95%, including from about 90% to about 99%, and further from about 95% to about 99% of the working fluid 132 fed into each of the plurality of plasma torches 104 is recycled through melting vessel 14 (i.e., at least about 90%, such as at least about 95%, including from about 90% to about 99%, and further from about 95% to about 99% of the total working fluid 132 fed into each of the plurality of plasma torches 104 is recycled working fluid 132b as shown in FIG. 5).

While the above embodiments have been described with reference to a fusion down draw process, it is to be understood that such embodiments are also applicable to other glass forming processes, such as float processes, slot draw processes, up-draw processes, tube drawing processes, and press-rolling processes.

It will be apparent to those skilled in the art that various modifications and variations can be made to embodiment of the present disclosure without departing from the spirit and scope of the disclosure. Thus, it is intended that the present disclosure cover such modifications and variations provided they come within the scope of the appended claims and their equivalents.

1. An apparatus for melting raw batch materials into molten glass comprising:
a chamber configured to confine molten glass up to a predetermined level within the chamber;
a feed port configured to feed raw batch materials into the chamber; and
a plurality of thermal plasma torches positioned above the predetermined level, each plasma torch configured to thermally decompose a working fluid fed therein and emit a plasma flame into the chamber.

2. The apparatus of claim 1, wherein the feed port is positioned on a first wall of the chamber and the plurality of thermal plasma torches are positioned on second and third walls of the chamber, the second and third walls each extending in directions that are generally parallel to each other and generally perpendicular to the first wall.

3. The apparatus of claim 1, wherein the apparatus comprises a plurality of electrodes positioned below the predetermined level.

4. The apparatus of claim 1, wherein the apparatus does not comprise a combustion burner.

5. The apparatus of claim 1, wherein the feed port is configured to feed raw batch materials into the chamber without the raw batch materials contacting the plasma flame of any of the plurality of plasma torches.

6. The apparatus of claim 1, wherein each plasma torch is configured to emit a plasma flame in a direction that is generally parallel to the predetermined level.

7. The apparatus of claim 1, wherein the plurality of plasma torches comprise alternating current (AC), direct current (DC), or radio frequency (RF) plasma torches.

8. The apparatus of claim 1, wherein a temperature of the plasma flame is at least about 2000° C.

9. The apparatus of claim 1, wherein the working fluid is selected from water hydrogen, helium, neon, or argon.

10. The apparatus of claim 1, wherein the apparatus is configured to recycle at least about 90% of the working fluid fed into each of the plurality of plasma torches.

11. A method for melting raw batch materials into molten glass comprising:
feeding raw batch materials into a chamber through a feed port;
heating the chamber with a plurality of plasma torches positioned above a predetermined level in the chamber, each plasma torch thermally decomposing a working fluid fed therein and emitting a plasma flame into the chamber; and
melting the raw batch materials into molten glass up to the predetermined level.

12. The method of claim 11, wherein the feed port is positioned on a first wall of the chamber and the plurality of thermal plasma torches are positioned on second and third walls of the chamber, the second and third walls each extending in directions that are generally parallel to each other and generally perpendicular to the first wall.

13. The method of claim 11, wherein the method comprises heating the chamber with a plurality of electrodes positioned below the predetermined level.

14. The method of claim 11, wherein the method does not comprise heating the chamber with a combustion burner.

15. The method of claim 11, wherein the raw batch materials are fed into the chamber without the raw batch materials contacting the plasma flame of any of the plurality of plasma torches.

16. The method of claim 11, wherein each plasma torch emits a plasma flame in a direction that is generally parallel to the predetermined level.

17. The method of claim 11, wherein the plurality of plasma torches comprise alternating current (AC), direct current (DC), or radio frequency (RF) plasma torches.

18. The method of claim 11, wherein a temperature of the plasma flame is at least about 2000° C.

19. The method of claim 11, wherein the working fluid is selected from water hydrogen, helium, neon, or argon.

20. The method of claim 11, wherein the apparatus recycles at least about 90% of the working fluid fed into each of the plurality of plasma torches.
